(19) United States
(12) Patent Application Publication
(10) Pub. No.: US 2025/0378609 A1
(43) Pub. Date: Dec. 11, 2025

(54) Style-Aware Drag-and-Drop Insertion of Subjects into Images

(71) Applicant: Google LLC, Mountain View, CA (US)

(72) Inventors: Nataniel Ruiz Gutierrez, Boston, MA (US); Shlomo Fruchter, Ness Ziona (IL)

(21) Appl. No.: 19/232,551

(22) Filed: Jun. 9, 2025

Related U.S. Application Data
(60) Provisional application No. 63/658,118, filed on Jun. 10, 2024.

(51) Int. Cl. G06T 11/60; G06T 7/12

(52) U.S. Cl. CPC G06T 11/60; G06T 7/12

(57) ABSTRACT

Methods are provided for accurate and reduced-cost insertion of subjects (e.g., people, animals) from one source image into a target image, matching the inserted subject into the style of the target image while preserving the pose, identity, and other aspects of the subject and also integrating the style-translated subject into the target image with respect to shadows, occlusion, and other aspects of the target environment. These methods include fine-tuning a diffusion model to recover an image of the subject conditioned on an auxiliary input description (e.g., a token sequence) of the subject that is, itself also learned. Style information from a target image is then imposed on the fine-tuned model, conditioned on the learned auxiliary input, to generate a style-translated image of the subject. The translated subject is then inserted into the target image and a subject insertion model applied to integrate it therein.

### CROSS-REFERENCE TO RELATED APPLICATIONS

The present application is a non-provisional patent application claiming priority to U.S. Provisional Patent Application No. 63/658,118, filed Jun. 10, 2024, the contents of which are hereby incorporated by reference.

### BACKGROUND

A variety of machine learning models are available to generate images de novo (e.g., based on a textual input), to translate the style of an image (e.g., to a style of an auxiliary image), or to perform other modifications of images with respect to the style in which they represent their contents. However, translating the style of a specific subject in an image (e.g., an anthropomorphic character) while maintaining the overall ‘identity’ of that character remains difficult and, if possible, computationally expensive. It is also difficult to integrate such a translated subject into a background accurately (e.g., adding or removing shadows, reflections, or other lighting and environmental effects as appropriate and in the correct style) and in a computationally inexpensive manner. For example, while inpainting has been attempted to accomplish this task, inpainting is computationally expensive and often generates poor-quality outputs.

### SUMMARY

In a first aspect, a computer-implemented method is provided that includes: (i) receiving an image of a subject and a target image; (ii) fine-tuning a diffusion model to predict the image of the subject based on a noisy version of the image of the subject, wherein fine-tuning the diffusion model to predict the image of the subject includes learning an auxiliary input that conditions an output of the diffusion model in a semantic embedding space; (iii) executing the fine-tuned diffusion model, with the learned auxiliary input applied thereto and with style information determined from the target image imposed on the fine-tuned diffusion model, to generate a second image of the subject, wherein the second image of the subject depicts the subject in a style of the target image; and (iv) using a subject insertion model to generate an output image that depicts the subject as depicted in the second image integrated into an environment depicted by the target image.

In a second aspect, a method for training a subject insertion model is provided that includes: (i) using a pre-trained subject insertion model to remove a plurality of subjects from respective stylized images to generate a first plurality of training images, wherein the stylized images are not photographic representations of real scenes, and wherein the pre-trained subject insertion model has been trained using photographic representations of real scenes; (ii) removing, from the first plurality of training images, images wherein subject removal has been performed unsuccessfully to generate a first filtered plurality of training images; and (iii) using the first filtered plurality of training images to fine-tune the pre-trained subject insertion model.

In another aspect, a non-transitory computer readable medium is provided having stored thereon program instructions executable by at least one processor to cause the at least one processor to perform any of the above methods.

In another aspect a system is provided that includes: (i) at least one processor; and (ii) a non-transitory computer-readable medium, having stored therein instructions executable by the at least one processor to cause the system to perform any of the above methods.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation

### BRIEF DESCRIPTION OF THE FIGURES

The patent or application file contains at least one drawing executed in color. Copies of this patent or patent application publication with color drawings will be provided by the Office upon request and payment of the necessary fee.

The accompanying drawings are included to provide a further understanding of the system and methods of the disclosure and are incorporated in and constitute a part of this specification. The drawings illustrate one or more embodiment(s) of the disclosure, and together with the description serve to explain the principles and operation of the disclosure

FIG. 1 illustrates a flowchart of an example machine learning model training and inference process.

FIG. 2 illustrates aspects of an example system.

FIG. 3A illustrates a flowchart of an example method.

FIG. 3B illustrates a flowchart of an example method.

FIG. 4 illustrates a flowchart of an example method.

FIG. 5 illustrates a flowchart of an example method.

FIG. 6 illustrates a flowchart of an example method.

FIG. 7 illustrates a flowchart of an example method.

FIG. 8 depicts experimental results.

FIG. 9 depicts experimental results.

FIG. 10 depicts experimental results.

FIG. 11 depicts experimental results.

FIG. 12 depicts experimental results.

FIG. 13 depicts experimental results.

### DETAILED DESCRIPTION

### I. Overview

It can be desirable in many applications to ‘drag and drop’ an image of a subject (e.g., a stylized image of a cartoon character or object, or a photograph or other photorealistic representation of a real person or other real subject) into a target image of a background, translating the style of the subject to the style of the background and integrating the subject into the background (e.g., by adding realistic reflections, shadows, occlusions, etc.) while also preserving the ‘identity’ of the subject (e.g., the pose, expression, semantic associations, or other non-style identifying information about the subject). It is also desirable to accomplish such a task in a fast, computationally inexpensive manner.

The embodiments described herein provide a fast, computationally efficient method for accomplishing the task of incorporating a subject into a target image, translating the style of the subject to the style of the target image while preserving the identity of the subject and also integrating the style-translated subject into the target image. These embodiments include fine-tuning a diffusion model, which is conditioned on an auxiliary descriptive input (e.g., a textual input defining the desired output of the model), to specifically recover the source image of the subject while also learning the auxiliary descriptive input. The fine-tuned diffusion model can then be executed, conditioned on the learned auxiliary descriptive input and with ‘style’ information from the target image imposed on the model, to generate a second image of the subject that has been translated into the style of the target image but that still hews to the identity of the subject as depicted in the source image.

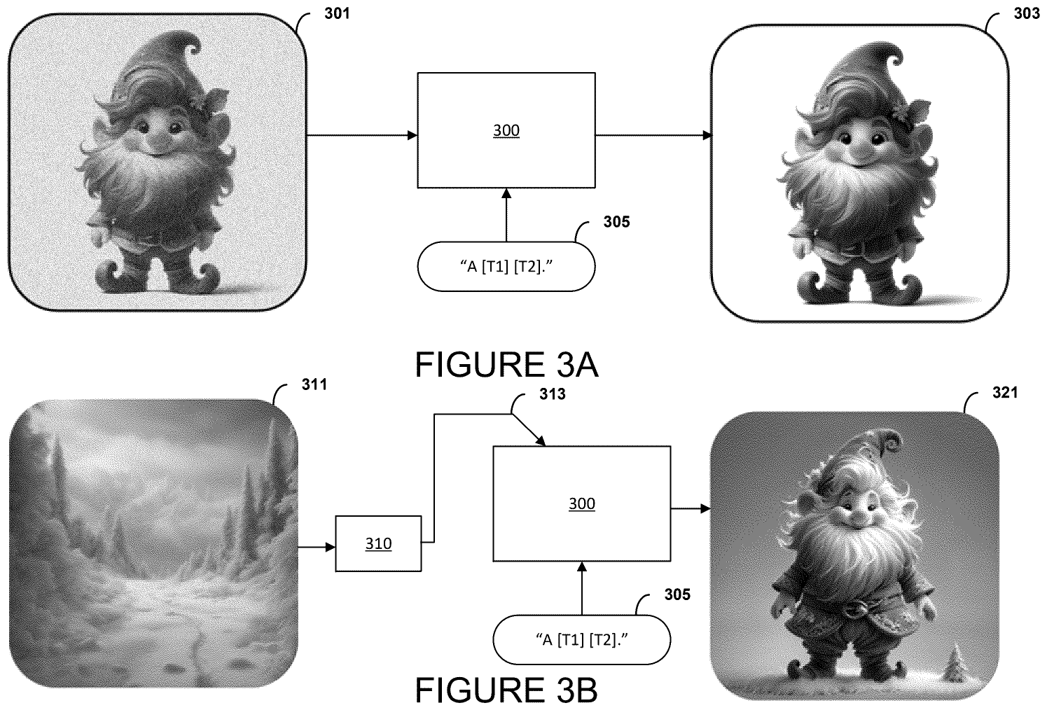

FIGS. 3A and 3B depict aspects of an example embodiment of such a method. FIG. 3A depicts aspects of an example process for fine-tuning a diffusion model 300 to recover a source image of a subject (e.g., a version 301 of a source image that has been corrupted by noise) conditioned on an auxiliary input 305 (e.g., a textual description of the subject, a sequence of tokens that represent the subject). This process includes generating an output image 303 of the subject; differences between the recovered output image 303 and the source image can provide a rich source of feedback information for training both the fine-tuned parameters of the model 300 (e.g., one or more rank decomposition matrices for at least one layer of the model 300 or some other constrained space for fine-tuning the parameters of the model 300) and the specifics of the auxiliary input 305 (e.g., learning a constrained set of words/tokens of the auxiliary input 305 by selecting the words/tokens from a dictionary and/or learning ‘personalized’ tokens in a token vector embedding space without such constraint).

Once the model 300 has been fine-tuned in this manner (and thus has come to specifically represent the subject), it can be used to generate a style-translated version of the subject. FIG. 3B depicts aspects of an example of such a process. Information about the style of a target image 311 is determined. The target image 311 could be a painted, cartoon, edited or filtered photograph, edited or filtered photorealistic image, or other variety of stylized image (e.g., or a real locale) or could be a non-stylized photograph or other photorealistic image. As shown in FIG. 3B, this can include a model 310 (e.g., a Contrastive Language-Image Pre-training (CLIP) model) generating style information 313 (e.g., a vector in a style embedding space) that represents the style of the target image 311. This style can then be imposed onto the fine-tuned subject-specific model 300, e.g., by an adapter model (e.g., IP-Adapter) injecting image features of the target image embedding into at least one layer of the diffusion model 300. The diffusion model 300 is then run, conditioned on the trained auxiliary input 305, to generate an output image 321 of the subject in the style of the target image 311.

Such a method facilitates more efficient and accurate identity-preserving style translation of a subject because the identity of the subject is represented in both the auxiliary descriptive input (e.g., as one or more words or other tokens (like “jolly elf”)) and the fine-tuning of the parameters of the diffusion model. The use of the learned auxiliary input allows the intrinsic, broad knowledge of the diffusion model to be leveraged to represent more generic aspects of the identity of the subject, while the fine-tuning allows more subtle aspects of the identity to be learned. Additionally, the use of the auxiliary input allows the fine-tuning to be performed in fewer iterations, decreasing computational cost while preserving the accuracy of preservation of the subject's identity. Style transfer techniques can then be used to impose the target image style on the identity-trained fine-tuned diffusion model.

The use of a diffusion model allows the subject image itself to be used to generate training data by adding varying amounts of noise thereto and then running an iteration of inference with the model; such training can also provide rich, high-resolution loss information for the training. The aspect(s) of the auxiliary inputs that are subjected to training could be related to the nature of the auxiliary input.

For example, if the auxiliary input receives an input sentence or other type of token string, then a partially static and partially learned token string could be used. In a particular example, the auxiliary input could be “A [BLANK1][BLANK2].” or “A picture of a [BLANK1][BLANK2].” where BLANK1 and BLANK2 are tokens learned while fine-tuning the diffusion model. Learning such tokens could include selecting the tokens from an enumerated set of tokens (e.g., “A friendly goblin,” with ‘friendly’ and ‘goblin’ being tokens selected from an enumerated dictionary of tokens that includes adjectives and nouns) or learning embeddings for personalized tokens in the token embedding space. The use of sentences or other token-sequence auxiliary inputs can also allow for modifications of the subject to be easily imposed by modifying the token sequence, e.g., adding tokens to specify the modification (e.g., “A picture of a sitting friendly goblin.” or “A picture of a sitting [BLANK1][BLANK2].” where BLANK1 and BLANK2 are learned personalized token embeddings).

The method used to fine-tune the model could also be selected to increase computational efficiency. For example, the parameters of the diffusion model could be frozen and only a restricted set of modifying parameters (e.g., rank decomposition matrix(es) for one more layers of the diffusion model) adjusted during learning to fine-tune the diffusion model by imposing modifications to the frozen parameters.

A variety of methods could be used to impose the style of the target image (e.g., 311) onto the diffusion model (e.g., 300). For example, style information (e.g., style features extracted from embeddings determined from the target image) could be injected into one or more layers of the fine-tuned diffusion model. In a particular example, (i) the diffusion model (e.g., 300) could include UNet or some other multi-layer transformer model, (ii) an embedding (e.g., 313) that represents the style of the target image could be determined (e.g., by applying the target image to the Contrastive Language-Image Pre-training model or some other model (e.g., 310)), and then (iii) an adapter model (e.g., IP-Adapter) could be used to inject image features of the target image embedding into at least one layer of the diffusion model (e.g., 300).

Once the diffusion model and its auxiliary inputs have been used to generate a style-translated image of the subject, the subject can be segmented from the generated style-translated image and copied into the target image (e.g., according to a location specified by a user using a ‘drag and drop’ user interface) to generate a first output image. Inpainting can be used to accomplish the integration of the copied subject into the target image, however, such methods are more computationally expensive than the present method, and also frequently result in poor-quality images. Instead, the first output image could be applied to a pre-trained subject insertion model to accomplish subject integration into the target image more efficiently.

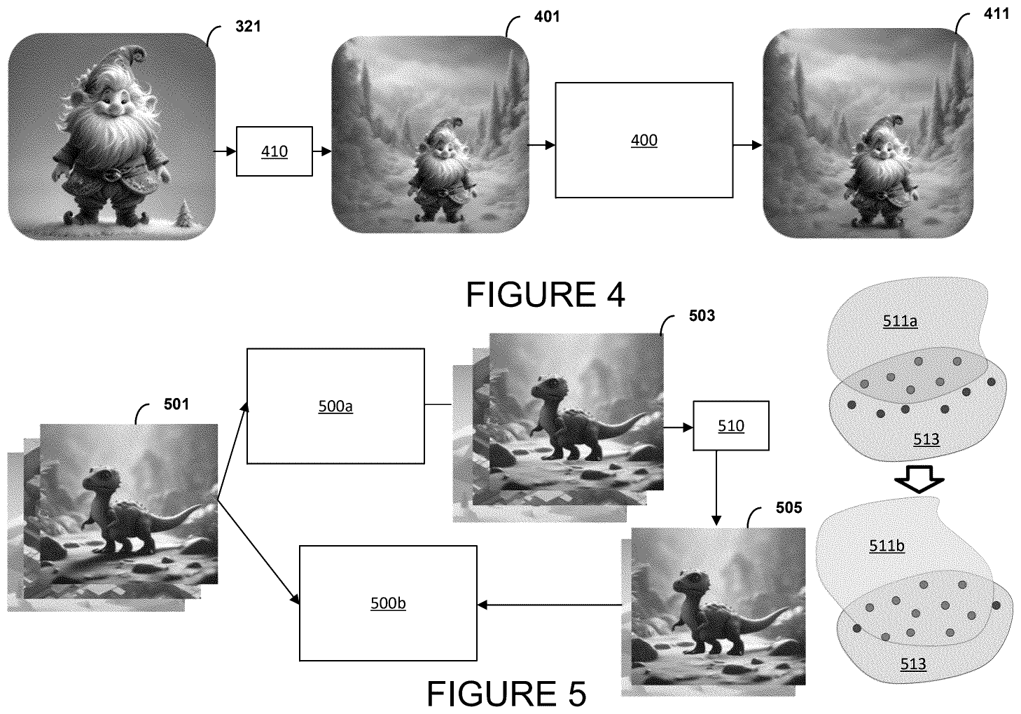

FIG. 4 depicts aspects of an example embodiment of such a method. An image 321 of a subject that has been translated into the style of a target image 311 is segmented 410 and composited into the target image 311, generating an intermediate image 401. The intermediate image 410 includes the style-translated subject copied into the target image 311, but without the subject integrated therein, e.g., without shadows, occlusions, reflections, or other modifications applied to the background and/or the subject within the intermediate image 410 to realistically represent the presence of the subject in the local represented by the target image 311. The intermediate image 401 is then applied to a subject integration model 400 (e.g., optionally in combination with a segmentation mask that represents the extent and location of the subject within the intermediate image 401), which then outputs an output image 411 that represents the subject realistically integrated into the environment represented by the target image 311. This can include applying shadows, occlusions, reflections, or other modifications to the background and/or the subject so as to realistically reflect the way that the subject would cast shadows, occlude, reflect, or otherwise impact the environment and to realistically reflect the way that the environment would cast shadows, occlude, reflect, or otherwise impact the subject, were the style-translated subject present in the environment represented by the target image 311.

A subject-adapted diffusion model as described herein (and associated auxiliary input(s)) can, in some embodiments, be transmitted to a local system (e.g., a cellphone, a laptop) in order to allow the model to be executed, using local computational resources available on the local system, to translate the subject into a target style and then to insert the style-translated subject into a background image. Such a downloaded model can also be re-used to translate the subject into a variety of different styles and/or background images. This can have the effect of reducing latency and bandwidth used to accomplish such tasks relative to, e.g., transmitting the additional styles and/or background images to the remote system that also performed the training of the diffusion model and auxiliary inputs. This is because, while many cellphones, laptops, tablets, or other commodity systems lack the ability (e.g., with respect to memory, storage, and processor resources) to adapt a diffusion model and learn the auxiliary inputs as described herein, such systems often possess sufficient local resources to execute such a fine-tuned diffusion model, to extract a style from a target input, to inject that style into the diffusion model, to crop a subject generated thereby, and to execute a subject insertion model to integrate the style-translated subject into a background image. Indeed, such non-training steps of the methods described herein can be adapted to the limited memory footprint and varying computational resources (e.g., CPUs, GPUs, TPUs) available on the sort of heterogeneous mobile SoCs available on cellphones, tablets, or other systems.

The methods described herein also exhibit improved performance with respect to a number of objective measures, including fidelity and model overfitting with respect to both the identity of the style-translated subject and the style of the subject relative to the style of the background. The methods described herein exhibit objective improvements relative to previous methods in the CLIP-I, CSD, and CLIP-T metrics with respect to fidelity of the style-translated subject to the style of the target background image and improvements relative to the previous methods in the SSIM metric with respect to over-fitting. The methods described herein exhibit objective improvements relative to previous methods in the DINO, CLIP-I, CLIP-T Simple, and CLIP-T Detailed metrics with respect to fidelity of the style-translated subject to the identity of the original subject image and improvements relative to the previous methods in the SSIM metric with respect to over-fitting.

Existing high-quality subject insertion models have been trained on photographic or otherwise photorealistic images of, e.g., real scenes and so may perform poorly on cartoons, artwork, highly filtered or edited images or real scenes, or otherwise stylized images as described herein. Embodiments described herein include training methods to fine-tune such “photorealistic” subject insertion models to perform well on stylized images using a very small amount of additional training data and using a small number of rounds of fine-tuning. These embodiments include using the pre-trained subject insertion model to remove (e.g., by removing shadows, reflections, etc.) stylized subjects from a set of stylized images to generate a set of training images. These training images are then filtered to remove those images wherein the subject removal has not been performed successfully (e.g., shadows or reflections remain or were incorrectly removed, other artifacts have been inserted) to generate a filtered plurality of training images. The filtered plurality of training images can then be used to fine-tune the subject insertion model to operate more accurately on stylized images. Such a process can also be performed iteratively, in a bootstrap fashion; as the model becomes more capable, it will be able to successfully perform subject removal on more of the input stylized images, expanding the training dataset available to further fine-tune the model.

FIG. 5 depicts aspects of an example embodiment of such a method for training a subject insertion model to perform better on highly filtered or edited photographs or other photorealistic images, painted images, artwork, cartoon images, or other types of stylized images. A training dataset 501 of subject-containing stylized images is applied to a pre-trained subject insertion/removal model 500a to generate an unfiltered dataset 503 of images of subjects that have been dis-integrated from their backgrounds (e.g., that have had removed therefrom shadows, occlusions, reflections, or other evidence of the realistic interaction between the subjects and the environments). This unfiltered dataset 503 is then filtered 510 (e.g., by manual filtering, by a model trained to determine whether a subject of an image has been accurately dis-integrated from the background of the image without an unacceptable amount or type of artifacts) to generate a filtered dataset 505 of images of subjects that have been correctly dis-integrated from their backgrounds. Pairs of images from the initial training dataset 501 (which represents subjects integrated into backgrounds) and from the filtered dataset 505 (which represents those subjects successfully dis-integrated from those backgrounds) are then used to fine-tune or otherwise retrain the pre-trained subject insertion/removal model 500a to realistically integrate subjects into backgrounds, even where one or both of the subject or background represent stylized contents (e.g., heavily filtered or otherwise stylized versions of photographs of real subjects/environments and/or style-translated versions thereof).

Such a training process can be performed iteratively, to adapt the domain of the subject insertion model 500a/500b from the domain of photorealistic images 511a to the domain of stylized images 513. FIG. 5 depicts available stylized images in the domain of stylized images 513 as circles. Prior to the training processes described herein, the domain 511a of a pre-trained subject insertion model that has been trained on photorealistic images may partially overlap with the domain of stylized images 513 such that a subset (indicated by green circles in the upper domain map) of the available stylized training images are able to be accurately dis-integrated by the model. Images of this subset are amongst the images represented in the filtered dataset 505. Once these images have been used to retrain the subject insertion model 500a/500b, its updated domain 511b has been slightly modified to overlap more of the domain of stylized images 513. Accordingly, the subject insertion model 500a/500b is now able to accurately dis-integrate the subjects from more of the images of the training dataset 501 (corresponding to circles that were red above, but green below). Thus, the retraining process can be performed iteratively, adding to the size of the filtered dataset 505 with each iteration as the domain of the model 500a/500b is adapted to the target domain of stylized images 513.

Filtering of the subject-removed training images that have been unsuccessful could include manually identifying the unsuccessful images. Additionally or alternatively, a model could be trained to perform such filtering, e.g., based on a smaller set of manually-filtered images.

### II. Example Machine Learning Models and Training Thereof

A machine learning model as described herein may include, but is not limited to: an artificial neural network (e.g., Transformers, layered models wherein each layer includes two or more sub-layers one or more of which could include artificial neural networks, convolutional neural networks, a recurrent neural network, a Bayesian network, a hidden Markov model, a Markov decision process, a logistic regression function, a support vector machine, a suitable statistical machine learning algorithm, and/or a heuristic machine learning system), a support vector machine, a regression tree, an ensemble of regression trees (also referred to as a regression forest), a decision tree, an ensemble of decision trees (also referred to as a decision forest), or some other machine learning model architecture or combination of architectures.

An artificial neural network (ANN) could be configured in a variety of ways. For example, the ANN could include two or more layers, could include units having linear, logarithmic, or otherwise-specified output functions, could include fully or otherwise-connected neurons, could include recurrent and/or feed-forward connections between neurons in different layers, could include filters or other elements to process input information and/or information passing between layers, or could be configured in some other way to facilitate the processing of input sequences, sets of embedding vectors representing input sequences, downstream vectors and/or set of vector determined by the operation of one or more layers or sublayers of a multi-layer model, and/or individual vectors (e.g., embedding vectors representing tokens of an input sequence, downstream vectors representing the processing of such embedding vectors by one or more layers or sublayers of a multi-layer model).

An ANN could include one or more filters that could be applied to the input and the outputs of such filters could then be applied to the inputs of one or more neurons of the ANN. For example, such an ANN could be or could include a convolutional neural network (CNN). Convolutional neural networks are a variety of ANNs that are configured to facilitate ANN-based classification or other processing based on images or other large-dimensional inputs whose elements are organized within two or more dimensions. The organization of the ANN along these dimensions may be related to some structure in the input structure (e.g., as relative location within the one-dimensional space of sequence of tokens can be related to similarity or relevance between tokens of the sequence).

In example embodiments, a CNN includes at least one two-dimensional (or higher-dimensional) filter that is applied to an input; the filtered input is then applied to neurons of the CNN (e.g., of a convolutional layer of the CNN). The convolution of such a filter and an input could represent the color values of a pixel or a group of pixels from the input, in embodiments where the input is an image. A set of neurons of a CNN could receive respective inputs that are determined by applying the same filter to an input. Additionally or alternatively, a set of neurons of a CNN could be associated with respective different filters and could receive respective inputs that are determined by applying the respective filter to the input. Such filters could be trained during training of the CNN or could be pre-specified. For example, such filters could represent wavelet filters, center-surround filters, biologically-inspired filter kernels (e.g., from studies of animal visual processing receptive fields), or some other pre-specified filter patterns.

A CNN or other variety of ANN could include multiple convolutional layers (e.g., corresponding to respective different filters and/or features), pooling layers, rectification layers, fully connected layers, or other types of layers. Convolutional layers of a CNN represent convolution of an input image, or of some other input (e.g., of a filtered, downsampled, or otherwise-processed version of an input image), with a filter. Pooling layers of a CNN apply non-linear downsampling to higher layers of the CNN, e.g., by applying a maximum, average, L2-norm, or other pooling function to a subset of neurons, outputs, or other features of the higher layer(s) of the CNN. Rectification layers of a CNN apply a rectifying nonlinear function (e.g., a non-saturating activation function, a sigmoid function) to outputs of a higher layer. Fully connected layers of a CNN receive inputs from many or all of the neurons in one or more higher layers of the CNN. The outputs of neurons of one or more fully connected layers (e.g., a final layer of an ANN or CNN) could be used to determine information about areas of an input image (e.g., for each of the pixels of an input image) or for the image as a whole.

Neurons in a CNN can be organized according to corresponding dimensions of the input. For example, where the input is a sequence of token (a one-dimensional input, with each token representing one or more words, or fractions of words, in an input text string), neurons of the CNN (e.g., of an input layer of the CNN, of a pooling layer of the CNN) could correspond to locations in the one-dimensional input string/sequence. Connections between neurons and/or filters in different layers of the CNN could be related to such locations.

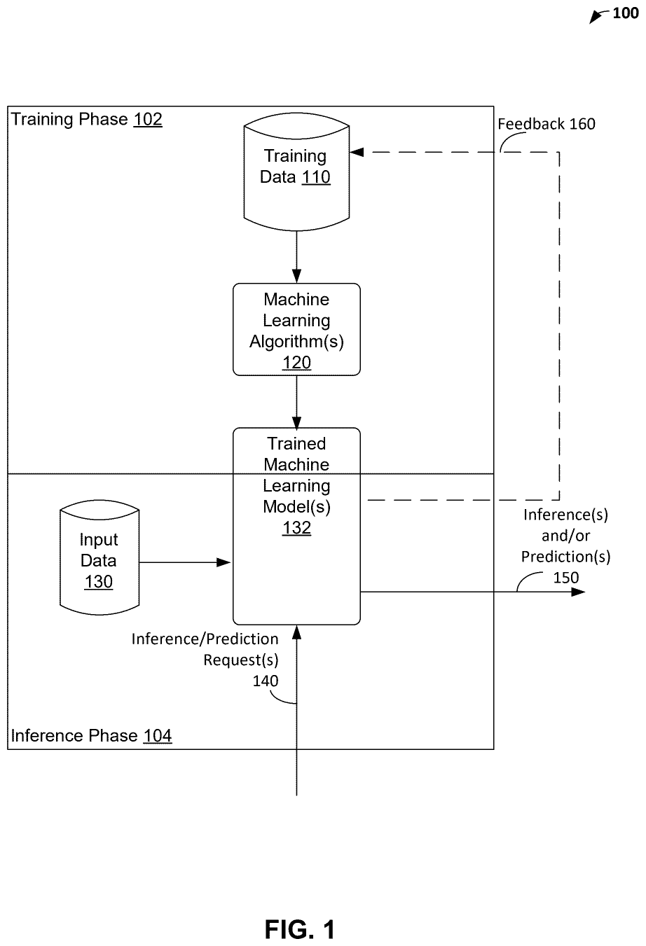

FIG. 1 shows diagram 100 illustrating a training phase 102 and an inference phase 104 of trained machine learning model(s) 132, in accordance with example embodiments. Some machine learning techniques involve training one or more machine learning algorithms on an input set of training data to recognize patterns in the training data and provide output inferences and/or predictions about (patterns in the) training data. Such output could take the form of filtered or otherwise modified versions of the input, e.g., an input image that represents a noisy version of a subject (or, in some examples, noise only, for use as the initial input of a diffusion-based image generation process) and a token-based description of the contents of the input image (e.g., a token sequence representing the sentence “A happy elf.”) could be modified by the machine learning model into an output image that represents a denoised version of the input image, conditioned on the token-based description. The resulting trained machine learning algorithm can be termed as a trained machine learning model. For example, FIG. 1 shows training phase 102 where one or more machine learning algorithms 120 are being trained on training data 110 to become trained machine learning model 132. Then, during inference phase 104, trained machine learning model 132 can receive input data 130 and one or more inference/prediction requests 140 (perhaps as part of input data 130) and responsively provide as an output one or more inferences and/or predictions 150.

As such, trained machine learning model(s) 132 can include one or more models of one or more machine learning algorithms 120. Machine learning algorithm(s) 120 may include, but are not limited to: an artificial neural network (e.g., a herein-described convolutional neural network, a recurrent neural network, a Bayesian network, a hidden Markov model, a Markov decision process, a logistic regression function, a support vector machine, a suitable statistical machine learning algorithm, and/or a heuristic machine learning system), a support vector machine, a regression tree, an ensemble of regression trees (also referred to as a regression forest), a decision tree, an ensemble of decision trees (also referred to as a decision forest), or some other machine learning model architecture or combination of architectures. For example, the trained machine learning model(s) 132 could include a plurality of artificial neural networks and other elements related to such networks (e.g., mixing or weighting matrices, sums, products, feedforward connections) arranged according to the multi-layer and sublayer architecture of a Transformer or similar model architecture designed to process input sequences. Machine learning algorithm(s) 120 may be supervised or unsupervised, and may implement any suitable combination of online and offline learning.

In some examples, machine learning algorithm(s) 120 and/or trained machine learning model(s) 132 can be accelerated using on-device coprocessors, such as graphic processing units (GPUs), tensor processing units (TPUs), digital signal processors (DSPs), and/or application specific integrated circuits (ASICs). Such on-device coprocessors can be used to speed up machine learning algorithm(s) 120 and/or trained machine learning model(s) 132. In some examples, trained machine learning model(s) 132 can be trained, reside and execute to provide inferences on a particular computing device, and/or otherwise can make inferences for the particular computing device.

During training phase 102, machine learning algorithm(s) 120 can be trained by providing at least training data 110 as training input using unsupervised, supervised, semi-supervised, and/or reinforcement learning techniques. Unsupervised learning involves providing a portion (or all) of training data 110 to machine learning algorithm(s) 120 and machine learning algorithm(s) 120 determining one or more output inferences based on the provided portion (or all) of training data 110. Supervised learning involves providing a portion of training data 110 to machine learning algorithm(s) 120, with machine learning algorithm(s) 120 determining one or more output inferences based on the provided portion of training data 110, and the output inference(s) are either accepted or corrected based on correct results associated with training data 110. In some examples, supervised learning of machine learning algorithm(s) 120 can be governed by a set of rules and/or a set of labels for the training input, and the set of rules and/or set of labels may be used to correct inferences of machine learning algorithm(s) 120.

Semi-supervised learning involves having correct results for part, but not all, of training data 110. During semi-supervised learning, supervised learning is used for a portion of training data 110 having correct results, and unsupervised learning is used for a portion of training data 110 not having correct results. Reinforcement learning involves machine learning algorithm(s) 120 receiving a reward signal regarding a prior inference, where the reward signal can be a numerical value. During reinforcement learning, machine learning algorithm(s) 120 can output an inference and receive a reward signal in response, where machine learning algorithm(s) 120 are configured to try to maximize the numerical value of the reward signal. In some examples, reinforcement learning also utilizes a value function that provides a numerical value representing an expected total of the numerical values provided by the reward signal over time. In some examples, machine learning algorithm(s) 120 and/or trained machine learning model(s) 132 can be trained using other machine learning techniques, including but not limited to, incremental learning and curriculum learning.

In some examples, machine learning algorithm(s) 120 and/or trained machine learning model(s) 132 can use transfer learning techniques. For example, transfer learning techniques can involve trained machine learning model(s) 132 being pre-trained on one set of data and additionally trained using training data 110. More particularly, machine learning algorithm(s) 120 can be pre-trained on data from one or more computing devices and a resulting trained machine learning model provided to computing device CD1, where CD1 is intended to execute the trained machine learning model during inference phase 104. Then, during training phase 102, the pre-trained machine learning model can be additionally trained using training data 110, where training data 110 can be derived from kernel and non-kernel data of computing device CD1. This further training of the machine learning algorithm(s) 120 and/or the pre-trained machine learning model using training data 110 of CD1's data can be performed using either supervised or unsupervised learning. Once machine learning algorithm(s) 120 and/or the pre-trained machine learning model has been trained on at least training data 110, training phase 102 can be completed. The trained resulting machine learning model can be utilized as at least one of trained machine learning model(s) 132.

In particular, once training phase 102 has been completed, trained machine learning model(s) 132 can be provided to a computing device, if not already on the computing device. Inference phase 104 can begin after trained machine learning model(s) 132 are provided to computing device CD1.

During inference phase 104, trained machine learning model(s) 132 can receive input data 130 and generate and output one or more corresponding inferences and/or predictions 150 about input data 130. As such, input data 130 can be used as an input to trained machine learning model(s) 132 for providing corresponding inference(s) and/or prediction(s) 150 to kernel components and non-kernel components. For example, trained machine learning model(s) 132 can generate inference(s) and/or prediction(s) 150 in response to one or more inference/prediction requests 140. In some examples, trained machine learning model(s) 132 can be executed by a portion of other software. For example, trained machine learning model(s) 132 can be executed by an inference or prediction daemon to be readily available to provide inferences and/or predictions upon request. Input data 130 can include data from computing device CD1 executing trained machine learning model(s) 132 and/or input data from one or more computing devices other than CD1.

Input data 130 can include images, segmentation maps (e.g., maps of the location, within a composite input image, of a subject that has been inserted therein), text strings, token strings, or other inputs. Other types of input data are possible as well.

Inference(s) and/or prediction(s) 150 can include output images and/or other output data produced by trained machine learning model(s) 132 operating on input data 130 (and training data 110). In some examples, trained machine learning model(s) 132 can use output inference(s) and/or prediction(s) 150 as input feedback 160. Trained machine learning model(s) 132 can also rely on past inferences as inputs for generating new inferences.

### III. Illustrative Systems

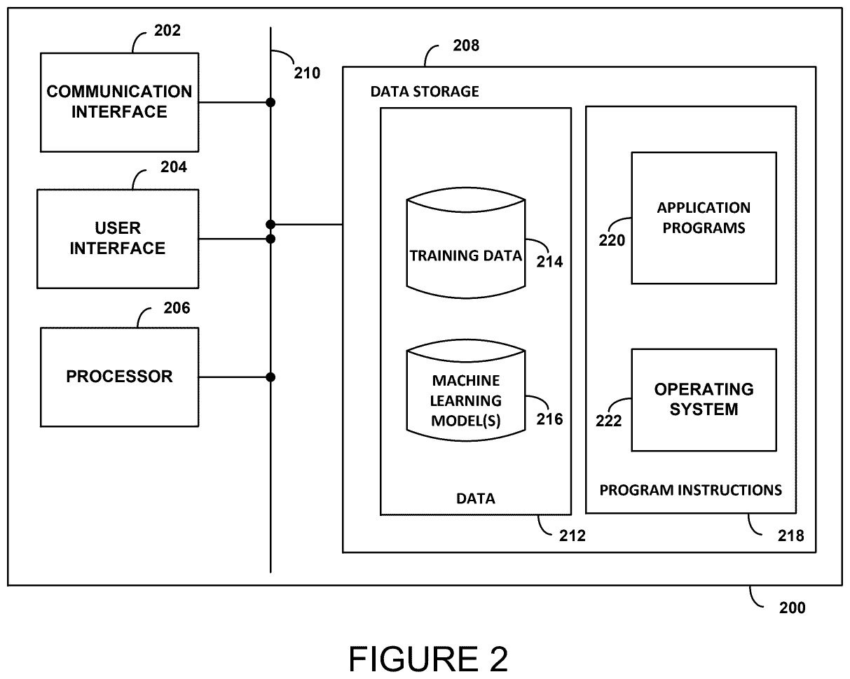

FIG. 2 illustrates an example computing system 200 that may be used to implement the methods described herein. By way of example and without limitation, computing system 200 may be a cellular mobile telephone (e.g., a smartphone), a computer (such as a desktop, notebook, tablet, or handheld computer, a server), elements of a cloud computing system, a robot, a drone, an autonomous vehicle, or some other type of device. It should be understood that computing system 200 may represent a physical computing device such as a server, a particular physical hardware platform on which a machine learning application operates in software, or other combinations of hardware and software that are configured to carry out machine learning or other functions as described herein. The computing system 200 could be a central system (e.g., a server, elements of a cloud computing system) that is configured to receive images, selections of images, locations of entities within images, or other information from a remote system (e.g., a from a user's phone) and to responsively transmit, to that remote system or to some other system, output images or other information generated by a method as described herein. In another example, such a remote system could train one or more machine learning models as described herein (e.g., subject style translation models) and transmit indications thereof (e.g., sets of parameter values thereof) to a local system (e.g., a cellphone) that could then execute the models to perform aspects of the methods described herein (e.g., to generate an image of a specified subject, that corresponds to the trained model, in the style of a target image). Additionally or alternatively, the computing system 200 could be such a remote system, configured to transmit images or other information to a central system, receive output images or other information in response, and/or to take some other actions as described herein.

As shown in FIG. 2, computing system 200 may include a communication interface 202, a user interface 204, a processor 206, and data storage 208, all of which may be communicatively linked together by a system bus, network, or other connection mechanism 210.

Communication interface 202 may function to allow computing system 200 to communicate, using analog or digital modulation of electric, magnetic, electromagnetic, optical, or other signals, with other devices, access networks, and/or transport networks. Thus, communication interface 202 may facilitate circuit-switched and/or packet-switched communication, such as plain old telephone service (POTS) communication and/or Internet protocol (IP) or other packetized communication. For instance, communication interface 202 may include a chipset and antenna arranged for wireless communication with a radio access network or an access point. Also, communication interface 202 may take the form of or include a wireline interface, such as an Ethernet, Universal Serial Bus (USB), or High-Definition Multimedia Interface (HDMI) port. Communication interface 202 may also take the form of or include a wireless interface, such as a Wifi, BLUETOOTH®, global positioning system (GPS), or wide-area wireless interface (e.g., WiMAX or 3GPP Long-Term Evolution (LTE)). However, other forms of physical layer interfaces and other types of standard or proprietary communication protocols may be used over communication interface 202. Furthermore, communication interface 202 may comprise multiple physical communication interfaces (e.g., a Wifi interface, a BLUETOOTH® interface, and a wide-area wireless interface).

In some embodiments, communication interface 202 may function to allow computing system 200 to communicate with other devices, remote servers, access networks, and/or transport networks.

User interface 204 may function to allow computing system 200 to interact with a user or other entity, for example to receive input from and/or to provide output to the user. Thus, user interface 204 may include input components such as a keypad, keyboard, touch-sensitive or presence-sensitive panel, computer mouse, trackball, joystick, microphone, and so on. User interface 204 may also include one or more output components such as a display screen which, for example, may be combined with a presence-sensitive panel. The display screen may be based on CRT, LCD, and/or LED technologies, or other technologies now known or later developed. User interface 204 may also be configured to generate audible output(s), via a speaker, speaker jack, audio output port, audio output device, earphones, and/or other similar devices.

Processor 206 may comprise one or more general purpose processors—e.g., microprocessors—and/or one or more special purpose processors—e.g., digital signal processors (DSPs), graphics processing units (GPUs), floating point units (FPUs), network processors, tensor processing units (TPUs), or application-specific integrated circuits (ASICs). In some instances, special purpose processors may be capable of executing machine learning models, training machine learning models, among other applications or functions. Data storage 208 may include one or more volatile and/or non-volatile storage components, such as magnetic, optical, flash, or organic storage, and may be integrated in whole or in part with processor 206. Data storage 208 may include removable and/or non-removable components.

Processor 206 may be capable of executing program instructions 218 (e.g., compiled or non-compiled program logic and/or machine code) stored in data storage 208 to carry out the various functions described herein. Therefore, data storage 208 may include a non-transitory computer-readable medium, having stored thereon program instructions that, upon execution by computing system 200, cause computing system 200 to carry out any of the methods, processes, or functions disclosed in this specification and/or the accompanying drawings. The execution of program instructions 218 by processor 206 may result in processor 206 using data 212.

By way of example, program instructions 218 may include an operating system 222 (e.g., an operating system kernel, device driver(s), and/or other modules) and one or more application programs 220 (e.g., functions for executing and/or training a machine learning model) installed on computing system 200. Data 212 may include training data (e.g. images of subjects and/or target environments, etc.) 214 and/or machine learning model(s) 216 that may be determined therefrom or obtained in some other manner.

Application programs 220 may communicate with operating system 222 through one or more application programming interfaces (APIs). These APIs may facilitate, for instance, application programs 220 transmitting or receiving information via communication interface 202, receiving and/or displaying information on user interface 204, and so on.

Application programs 220 may take the form of “apps” that could be downloadable to computing system 200 through one or more online application stores or application markets (via, e.g., the communication interface 202). However, application programs can also be installed on computing system 200 in other ways, such as via a web browser or through a physical interface (e.g., a USB port) of the computing system 200.

### IV. Example Methods

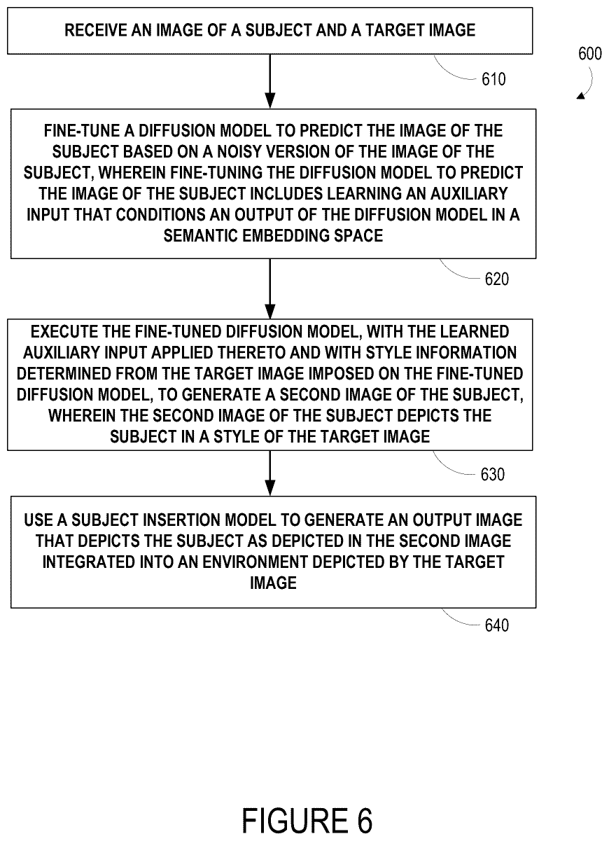

FIG. 6 is a flowchart of an example computer-implemented method 600. The method 600 includes receiving an image of a subject and a target image (610). The method 600 additionally includes fine-tuning a diffusion model to predict the image of the subject based on a noisy version of the image of the subject, wherein fine-tuning the diffusion model to predict the image of the subject includes learning an auxiliary input that conditions an output of the diffusion model in a semantic embedding space (620). The method 600 additionally includes executing the fine-tuned diffusion model, with the learned auxiliary input applied thereto and with style information determined from the target image imposed on the fine-tuned diffusion model, to generate a second image of the subject, wherein the second image of the subject depicts the subject in a style of the target image (630). Applying the learned auxiliary input to the fine-tuned diffusion model can include applying the learned auxiliary input, optionally along with additional input content, e.g., definite articles, punctuation, command fragments, or other content, to a token-based input of the fine-tuned diffusion model each time the fine-tuned diffusion model is inferenced to output a de-noised or otherwise improved version of an input noisy image of the subject (or, in an initial step of such an image generation process, to output a de-noised or otherwise improved version of an input image that is entirely noise). For example, the learned auxiliary input could be two words (or tokens representing words) “friendly elf,” and applying the learned auxiliary input to the fine-tuned diffusion model can include applying a token string representing “A friendly elf.” to a token-receiving auxiliary input of the fine-tuned diffusion model a plurality of times as the fine-tuned diffusion model is inferenced, in a noise diffusion context, to generate an image of a “friendly elf” by iteratively denoising generated images thereof. Imposing style information determined from the target image on the fine-tuned diffusion model can include applying modifications to one or more elements of the fine-tuned diffusion model (e.g., to attention, projection, and/or other matrices of one or more layers of the fine-tuned diffusion model) based on the determined style information, e.g., based on the output of an adapter model that has received an embedding vector representing the style information as input.

The method 600 additionally includes using a subject insertion model to generate an output image that depicts the subject as depicted in the second image integrated into an environment depicted by the target image (640). The method 600 could include additional or alternative features.

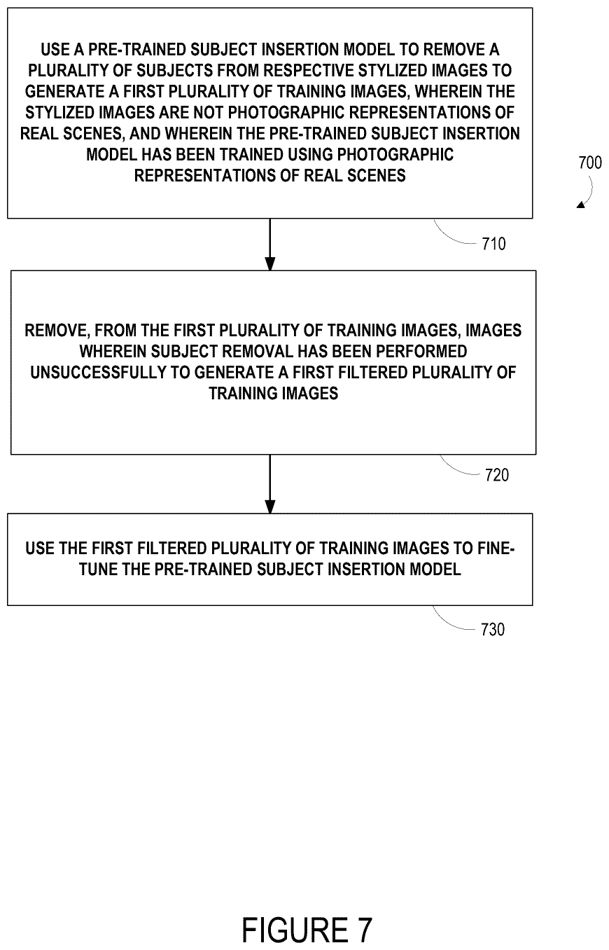

FIG. 7 is a flowchart of an example computer-implemented method 700 for training a subject insertion model. The method 700 includes using a pre-trained subject insertion model to remove a plurality of subjects from respective stylized images to generate a first plurality of training images, wherein the stylized images are not photographic representations of real scenes, and wherein the pre-trained subject insertion model has been trained using photographic representations of real scenes (710). The method 700 additionally includes removing, from the first plurality of training images, images wherein subject removal has been performed unsuccessfully to generate a first filtered plurality of training images (720). The method 700 additionally includes using the first filtered plurality of training images to fine-tune the pre-trained subject insertion model (730). The method 700 could include additional or alternative features.

### V. Example Embodiments and Experimental Results

The embodiments described herein were developed into a number of example implementations, which are described in greater detail in this section. Some of these example implementations were experimentally evaluated, and the results of such experimentation is also provided in this section.

Large text-to-image models are capable of generating high-quality images. However, controllability has previously been lacking in these models. For example, it would be beneficial to provide additional control with response to subject personalization, style learning, layout controls, and semantic controls.

The embodiments described herein can facilitate a variety of applications, including “style-aware drag-and-drop.” The embodiments herein will be described by way of non-limiting example implementations directed to this application. The application of these embodiments toward this application may be referred to herein as “Magic Insert.” These methods provide significant improvements relative to alternatives, e.g., relative to inpainting using a stylized subject, for example by combining Dreambooth, StyleDrop, and inpainting. Approaches of that type are very computationally expensive and achieve subpar results.

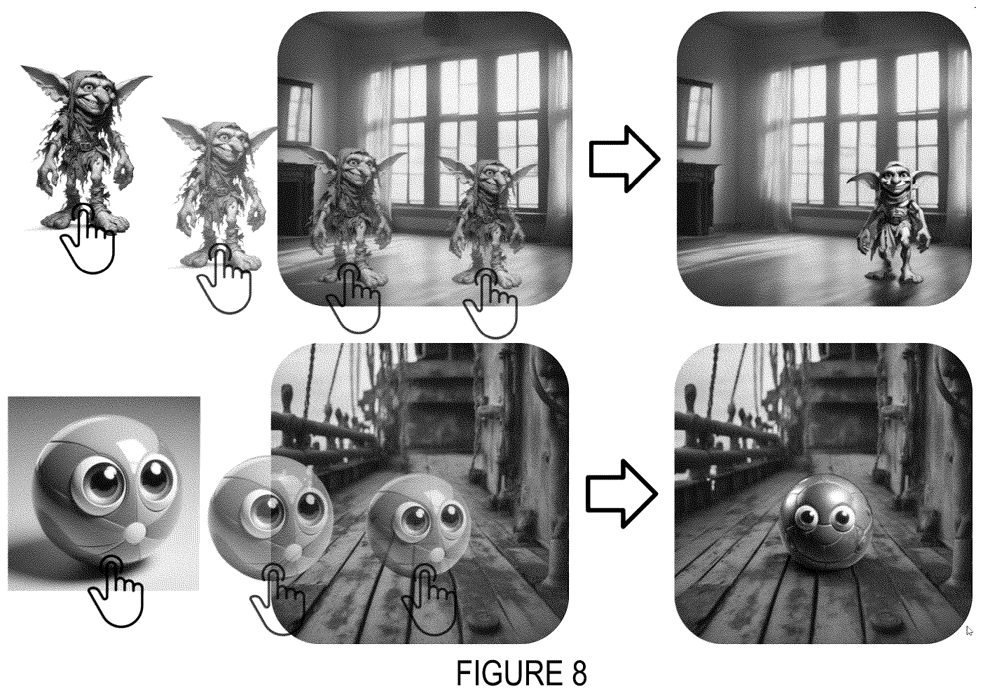

The implementation of Magic Insert described herein effectuates solutions to two sub-problems: style-aware personalization and realistic object insertion in stylized images. Previous attempts at style-aware personalization fail at fast learning of a subject, including all the intricacies of identity. Magic Insert uses adapter injection of style paired with subject-learning in the embedding and weight space of a diffusion model. FIG. 8 depicts examples of the use of the embodiments described herein to accomplish this application. Using Magic Insert a subject from an image with an arbitrary style (left) was able to be dragged and dropped onto another target image (middle) with a different style and achieve a style-aware and realistic insertion of the subject into the target image (right).

Additionally, Magic Insert does not inpaint directly into a target image after style-aware personalization of a subject. Instead, a high-quality subject is first generated and then inserted into the target image. Bootstrap domain adaptation is applied to progressively retarget a subject insertion model's initial distribution (e.g., in the space of photorealistic images) to a target distribution (e.g., the space of painted or otherwise stylized images). Bootstrap domain adaptation is used to adapt a subject insertion network that has been trained on real images to perform well on the stylized image domain, enabling the insertion of the generated stylized subject into the background image.

The Magic Insert method is greatly improved from previous methods, with the generated subject exhibiting strong adherence to the target style while preserving the essence and identity of the subject. Additionally obtaining realistic insertion of the stylized subject into the generated image. The method also provides flexibility in terms of the degree of stylization desired and how closely to adhere to the original subject's specific details and pose (or allow more novelty in the generation).

The embodiments herein formalize the problem of style-aware drag-and-drop, where an item (a subject or object) is dragged from one image into another. Specifically, in the present problem formulation, the subject reference image and the target image may be in vastly different styles. In such examples, the plausibility and realism of the subject insertion relative to the background is important.

To facilitate this end, the SubjectPlop dataset of subjects and backgrounds was generated that span widely different styles and overall semantics.

Magic Insert is composed of a style-aware personalization component and a style-consistent drag-and-drop component.

For style-aware personalization, strong and consistent results were obtained using subject learning in the embedding and weight space of a pre-trained diffusion model, along with adapter injection of style.

For drag-and-drop, bootstrap domain adaptation was used to progressively retarget a pre-trained model's initial distribution into a target distribution. This method was used to adapt an object insertion network trained on real images to perform well in the stylized image domain.

The style-aware drag-and-drop problem can be formalized as follows. Let Iₛ and Iₜ denote the space of subject and target images, respectively. Given a subject image xₛ∈Iₛ and a target image xₜ∈Iₜ, the goal is to generate a new image x∧ₜ∈Iₜ such that:
1) The subject from xₛ is inserted into x∧ₜ in a semantically consistent and realistic manner, accounting for factors such as occlusion, shadows, and reflections; and
2) The inserted subject in x∧ₜ adopts the style characteristics of the target image xₜ while preserving its essential identity and attributes from xₛ, facilitating insertion of the inserted subject into the target image (e.g., facilitating the generation or manipulation of shadows, occlusions, reflections, or other features to integrate the style-translated subject image into the target image).

Formally, a function h: Iₛ×Iₜ→Iₜ is learned that satisfies:

$$\begin{matrix}h ( {x}_{s} , {x}_{t} ) = x {\hat{}}_{t} & s . t . & x {\hat{}}_{t} ∼ p ( {x}_{t} \vert {x}_{s} , {x}_{t} )\end{matrix} \qquad ( 1 )$$

where p(xₜ|xₛ,xₜ) represents the conditional distribution of the target image given the subject and target images. This distribution encapsulates the desired properties of semantic consistency, realistic insertion, and style adaptation. To learn the function ƒ, the problem was decomposed into two sub-tasks: style-aware personalization and realistic object insertion in stylized images. Style-aware personalization focuses on generating a subject that adheres to the target image's style while maintaining its identity. Realistic object insertion aims to seamlessly integrate the stylized subject into the target image, accounting for the scene's geometry and lighting conditions. By addressing these sub-tasks, the style-aware drag-and-drop problem can be solved to generate visually coherent and compelling results.

To facilitate the performance and evaluation of the style-aware drag-and-drop problem, the SubjectPlop dataset was created.

FIGS. 3A and 3B depict aspects of the Style-Aware Personalization process. To generate a subject that fully respects the style of the target image yet conserves the subject's essence and identity, a diffusion model 300 was personalized to the subject (depicted in image 303) in both weight and embedding space, by training LoRA deltas on top of the pre-trained diffusion model 300 and simultaneously training the embedding of two text tokens (T1 and T2 of auxiliary input 305) using the diffusion denoising loss (the method depicted in FIG. 3A). Then, this personalized diffusion model 300 was used to generate the style-aware subject by embedding 313 the style of the target image 311 and conducting adapter style-injection into select upsampling layers of the model 300 during denoising, conditioned on the ‘trained’ auxiliary input 305.

SubjectPlop consists of a diverse collection of subjects generated using a first model and backgrounds generated using a second model (specifically, the open-source SDXL model). The dataset includes various subject types, such as animals and fantasy characters, and both subjects and backgrounds exhibit a wide range of styles, including 3D, cartoon, anime, realistic, and photographic. The diversity in color hues and lighting conditions ensures comprehensive coverage of different scenarios for evaluation.

The dataset comprises 20 distinct backgrounds and 35 unique subjects, allowing for a total of 700 possible subject-background pairs. This rich set of test cases enabled the assessment of performance and generalization capabilities of the style-aware drag-and-drop techniques described herein, as well as prior methods for comparison. SubjectPlop provides a standardized benchmark for evaluating and comparing different approaches to the style-aware drag-and-drop problem.

The style-aware personalization approach is illustrated in FIGS. 3A and 3B. Let f_{θ} denote a pre-trained diffusion model with parameters θ. Given a subject image xₛ∈Iₛ, the method personalizes f_{θ} on xₛ in both the weight and embedding space.

In the first step, LoRA (Low-Rank Adaptation) deltas Δ_{θ} were trained on top of f_{θ}, which allowed for efficient fine-tuning while preserving the model's 300 original capabilities. Simultaneously, embeddings e₁, e₂ ∈R^{d} were learned for two personalized text tokens (T1 and T2 of 305 in FIGS. 3A and 3B), where d is the embedding dimensionality. The LoRA deltas and embeddings were jointly trained using the diffusion denoising loss:

$${ℒ}_{joint} = {𝔼}_{t , ϵ} [ {‖ ϵ - {ϵ}_{{θ}^{′}} ( {x}_{θ}^{t} , t , [ {e}_{1} ; {e}_{2} ] ) ‖}_{2}^{2} ] \qquad ( 2 )$$

where t˜ [symbol] (0,1), ϵ˜ [symbol] (0, I),

$${x}_{S}^{t} = \sqrt{\overline{{α}_{t}}} {x}_{S} + \sqrt{1 - \overline{{α}_{t}}} ϵ ,$$

and ϵ_{θ}, is the noise prediction of the adapted model f_{θ}′ with parameters θ′=θ+Δ_{θ}. The joint optimization of Δ_{θ}, e₁, and e₂ is performed using the loss [symbol] ⱼₒᵢₙₜ. These personalized text tokens [e₁; e₂] serve as a compact representation of the subject's identity. By performing embedding and weight-space learning simultaneously, e.g., with two text tokens, captures the subject's identity more strongly while allowing sufficient editability to introduce the target style, in a manner that reduces computational cost to achieve a specified level of model accuracy (e.g., by allowing the token to represent broad, high-level aspects of subject identity, while the fine-tuning can ‘focus’ on more fine-grained aspects).

In the second step, the personalized diffusion model f_{θ}′ (300) was used to generate the style-aware subject x∧ₛ (321). To infuse the target image xₜ's (311) style into x∧ₛ, style injection was employed. Specifically, a style embedding (313) eₜ=CLIP(xₜ) of xₜ (311) was generated using a CLIP encoder (310) or other suitable style embedding model. A frozen IP-Adapter model v (or other injection model, e.g., adapted to a different type of diffusion model used for the previous personalization step) was then used to inject er into a subset of the UNet blocks of f_{θ}′ (300) during inference conditioned on the auxiliary input 305 (e.g., starting from a seed image composed only of noise):

$$x {\hat{}}_{s} = {f}_{θ}^{′} ( [ {e}_{1} ; {e}_{2} ] , v ( {e}_{t} ) ) \qquad ( 3 )$$

Such a method can omit content/style embedding separation and inject into a personalized model. This ensures that x∧ₛ maintains the subject's identity while adopting xₜ's style characteristics.

By combining style-aware personalization with style injection, the methods described herein generate subjects that are capable of harmoniously blending into the target image (e.g., that can have shadows, occlusions, reflections, or other integration features applied accurately thereto) while retaining their essential identity, effectively tackling the first challenge of style-aware drag-and-drop and enabling the creation of visually coherent and style-consistent results.

FIG. 4 depicts aspects of the subsequent subject insertion process. In order to insert the style-aware personalized subject, a segmented version 321 of the subject was inserted onto the target image 311 to generate a composite image 401. A subject insertion model 400 was then applied to the non-shadowed composite image 401—this creates context cues and realistically embeds the subject into the image 411 including shadows and reflections.

This problem of subject insertion can be improved by the bootstrap domain adaptation method (and related embodiments) described herein. Subject insertion is an important component of the style-aware drag-and-drop problem, as it involves integrating a stylized subject into a target background image. While diffusion-based inpainting approaches can be used, they still face challenges such as generating content in smooth regions, producing incomplete figures, erasing objects behind inserted subjects, and boundary harmonization. Instead, a subject insertion model can be employed to insert the subject directly and generate contextual cues such as shadows and reflections. Existing subject insertion models are trained on data captured in the real world, severely limiting their ability to generalize to images with diverse artistic styles.

Let Dᵣ denote the distribution of real-world images and Dₛ denote the distribution of stylized images (e.g., painted images, anime images, heavily filtered, edited, or otherwise processed photographic or other real-world images). Existing subject insertion models have been trained on samples from Dᵣ, but the goal herein is to adapt them to perform well on samples from Dₛ. To overcome this limitation, bootstrap domain adaptation was applied, a technique that enables a model to adapt its effective domain by leveraging a subset of its own outputs. As illustrated in FIG. 5, a subject removal/insertion model g_{θ} (500a/500b) was applied to first remove subjects and shadows from a dataset S (501)˜Dₛ belonging to the target domain, generating an unfiltered dataset 503. Subsequently, flawed outputs were filtered out 510 to obtain a filtered set of images S′ (505)⊆S, which was used to retrain the subject removal/insertion model (500a/500b).

The bootstrap domain adaptation process can be formalized as follows:

$$ω = arg {min}_{ω} {𝔼}_{( x , y ) \sim {S}^{′}} ℒ ( {g}_{ω} ( x ) , y ) \qquad ( 4 )$$

where ω denotes the adapted model (500a/500b) parameters, £ is the diffusion denoising loss, and (x,y) are pairs of input images and corresponding subject removal/insertion ground truths from the filtered set S_{f} (505). The concept of bootstrap domain adaptation is based on the observation that a diffusion model trained for subject insertion/removal on real-world data can generalize to a wider stylistic domain to some limited extent. By retraining the model on its own filtered outputs, its domain can be efficiently, and with reduced computational cost (e.g., relative to training a completely new model based on the target set of stylized images), re-trained to better handle stylized images.

The right pane of FIG. 5 demonstrates schematically the effect of bootstrap domain adaptation on the model's (500a/500b) distribution. The initial distribution, represented as p_{ω}(x) (511a), evolves after training, becoming p_{ω}*(x) (511b). Images that were initially treated incorrectly, shown as samples from Dₛ \S′ (red dots in the upper map), are subsequently handled correctly, as indicated by their inclusion in S′. During the bootstrap domain adaptation process, the model is trained only on the initially correct samples from S′ to further refine its performance on the target domain.

To facilitate the bootstrap domain adaptation process, a dataset S specifically tailored to the task was generated. The dataset comprises a diverse range of stylized images, carefully selected to represent the target domain Dₛ. By finetuning the subject removal/insertion model (400, 500a/500b) on this dataset using the bootstrap domain adaptation technique, it is made to effectively handle subject insertion in the context of style-aware drag-and-drop.

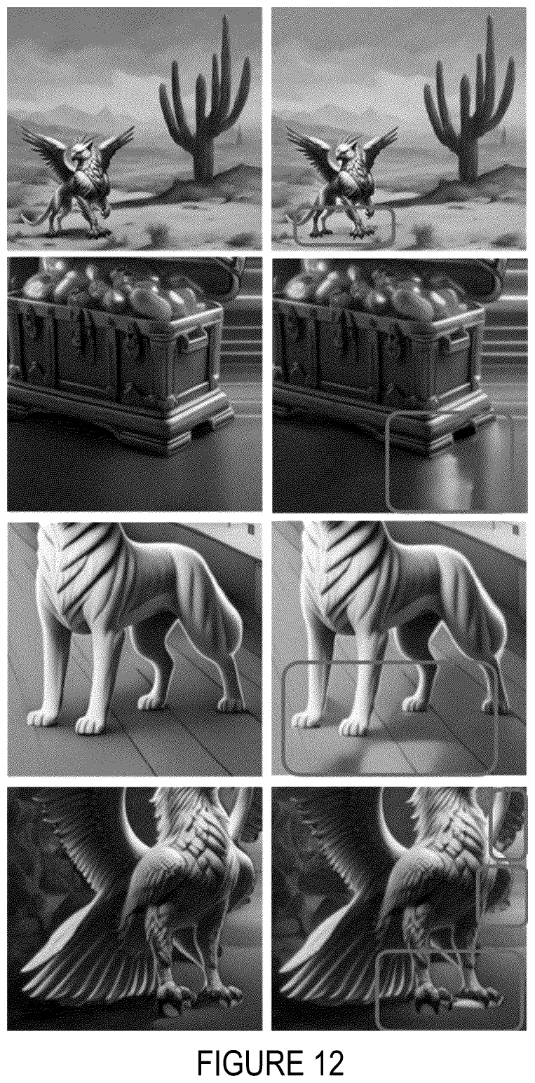

FIG. 12 depicts examples of the benefits of the bootstrap domain adaptation process described herein relative to using the pre-trained insertion module without bootstrap domain adaptation. The images on the left are images with subjects integrated therein using the insertion module fine-tuned using bootstrap domain adaptation, while the images on the left are images with subjects integrated therein using the insertion module without such fine-tuning (e.g., trained only on photorealistic image training datasets). As shown, inserting a subject with the pre-trained subject insertion module without bootstrap domain adaptation generates subpar results, with missing shadows and reflections, or added distortions and artifacts.

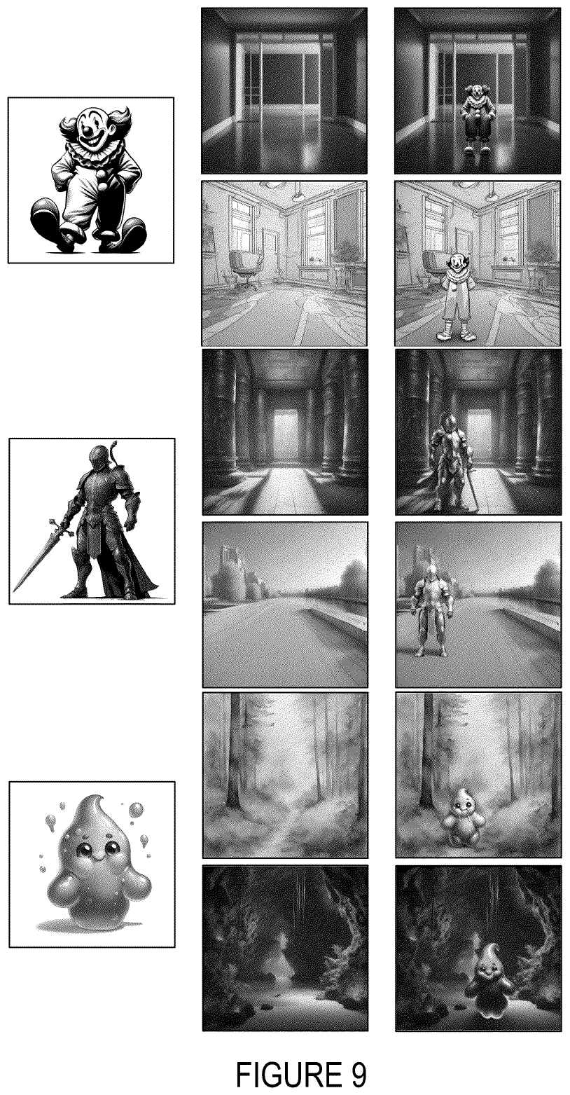

A gallery of qualitative results are presented in FIG. 9 to highlight the effectiveness and versatility of the Magic Insert method. The examples span a wide range of subjects and target backgrounds with vastly different artistic styles, from photorealistic scenes to cartoons, sketches, and paintings. For style-aware personalization the SDXL model was used, and for subject insertion a subject insertion model trained as described herein and based on a latent diffusion model architecture was used.

In each case, the methods described herein successfully extracted the subject from the source image and blended it into the target background, adapting the subject's appearance to match the background's style. Notice how the inserted subjects take on the colors, textures, and stylistic elements of the target images. The coherent shadows and reflections enhance the plausibility of the results.

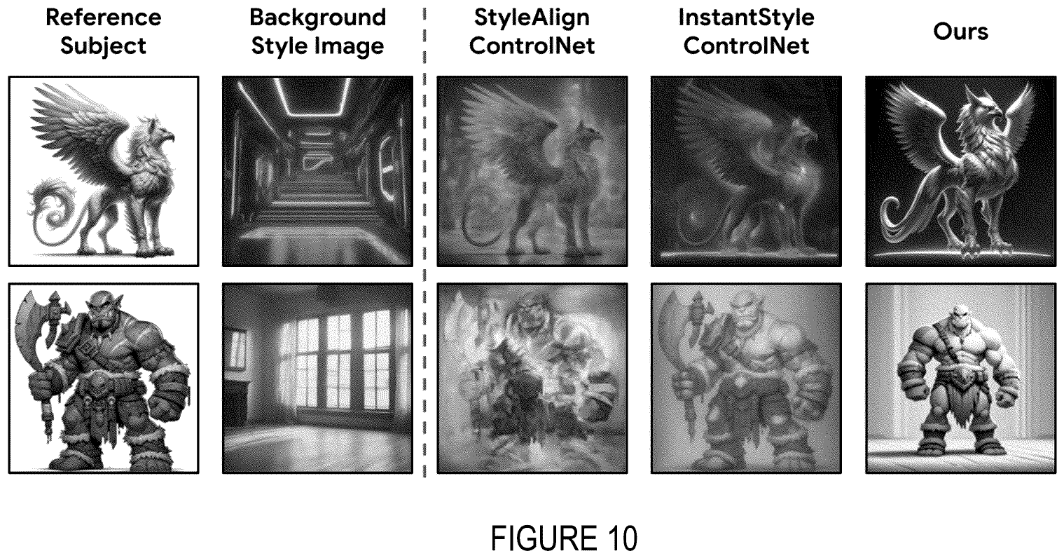

FIG. 10 depicts some comparisons of the style-aware personalization methods described herein (“Ours”) relative to the top performing baselines StyleAlign+ControlNet and InstantStyle+ControlNet. While the previous methods can yield decent outputs, they lag behind the style-aware personalization methods herein in overall quality.

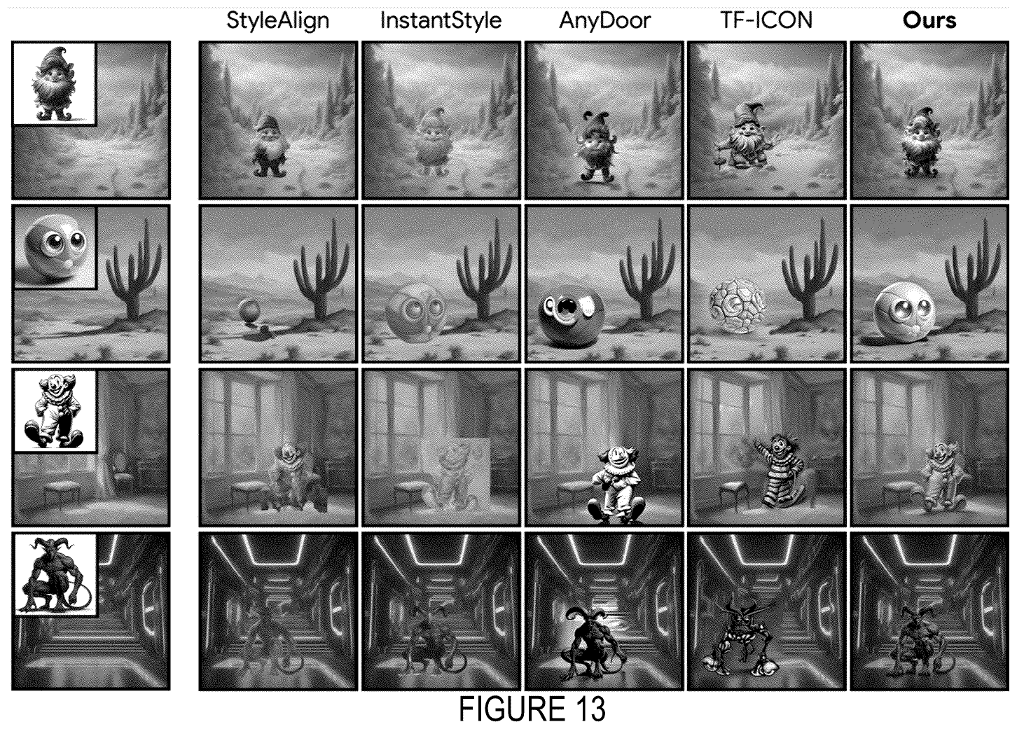

FIG. 13 depicts a broad comparison between the methods described herein (“Ours”) and alternative state-of-the-art methods StyleAlign, InstantStyle, TF-ICON, ObjectDrop and AnyDoor. The method described herein outperforms competing methods on subject identity preservation, accurate stylization and realistic insertion. The alternative methods struggle with artifacts, in-existent harmonization, erased objects, deformed subjects, and lack of appropriate no shadows or reflections. Harmonization-based methods like TF-ICON tend to fail on subject fidelity, style adherence, background erasure and lack of shadows and reflections. Non-stylized insertion methods like AnyDoor cannot stylize the inserted subject and can fail with subject distortions. StyleAlign and InstantStyle struggled with capturing subject fidelity and correct harmonization. The method described herein performed well with respect to these considerations.

TABLE 1
below compares the methods described herein (“Ours”) to alternative
methods with respect to subject fidelity (DINO, CLIP-I, CLIP-T
Simple, CLIP-T Detailed) and overfitting (SSIM). SSIM measures
structure and pose overfitting, lower values indicating better
performance. The methods described herein exhibit high subject
fidelity while having very low structure and pose overfitting.

| [symbol] | | | | | | |
|---|---|---|---|---|---|---|
| [symbol] | | | | | | |
| [symbol] | | | | | | |
| [symbol] | | | | | | |
| [symbol] | | | | | | |
| [symbol] | | | | | | |
| Ours ControlNet | 0.514 | 0.869 | 0.289 | 0.308 | 0.495 | 0.1252 |

[symbol]

indicates data missing or illegible when filed

Baseline comparisons were performed in order to compare the performance with respect to subject stylization of different baseline methods relative to the style-aware personalization methods described herein. The performance of these methods was evaluated with respect to subject fidelity, style fidelity, and structural overfitting. For subject fidelity (Table 1), the methods herein achieved high scores across various subject fidelity metrics (DINO, CLIP-I, CLIP-T Simple, CLIP-T Detailed) while maintaining low structure and pose overfitting (SSIM). This is beneficial with respect to being able to modify the pose of the subject, as well as other behaviors (editability using text for example). Regarding style fidelity (Table 2), the methods described herein demonstrated strong style-following performance (CLIP-I, CSD, CLIP-T) while keeping structure and pose overfitting low (SSIM). In summary, the methods described herein strike a balance between high subject and style fidelity while minimizing structure and pose overfitting. This can facilitate better, more accurate integration into target images (e.g., photorealistic target images) by improving the ability to generate shadows, occlusions, reflections, or other subject-integrating features in an output image. Some example outputs of the style-aware personalization methods described herein, along with examples from alternative baseline methods StyleAlign ControlNet and InstantStyle ControlNet, are depicted in FIG. 10.

TABLE 2
below compares the methods described herein to baselines with respect
to style fidelity (CLIP-I, CSD, CLIP-T) and overfitting (SSIM) across
different methods. SSIM measures structure and pose overfitting,
and lower values indicate better performance. The method described
herein (“Ours” in the table below) shows strong style-following
performance while having very low structure and pose overfitting.

| [symbol] | | | | | |
|---|---|---|---|---|---|
| [symbol] | | | | | |
| Ours ControlNet | 0.575 | 0.294 | 0.274 | 0.381 | 0.1252 |

[symbol]

indicates data missing or illegible when filed

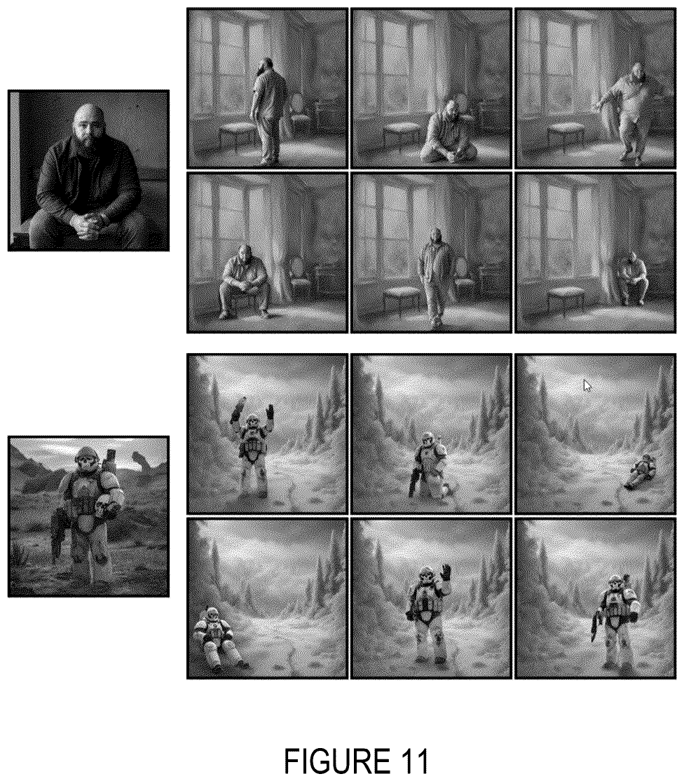

The style-aware personalization methods described herein allow for large changes in subject pose, with support from the diffusion model prior. Using an LLM, LLM-guided affordances were generated for different subjects by feeding an instruction prompt, the full background image, and the section of the background image in which the subject will be positioned. Using these LLM suggestions, the subject following these poses and environment interactions is generated and inserted in the appropriate space. These embodiments were employed, as demonstrated in FIG. 11, to insert subjects into images realistically with automatic interactions with the scene. FIG. 11 depicts examples of such an LLM guided pose modification for the Magic Insert methods described herein, with the LLM suggesting plausible poses and environment interactions for areas of the image and Magic Insert generating and inserting the stylized subject (generated from the reference image to the left) with the corresponding pose into the image, to generate the various example outputs corresponding to the commanded locations and poses.

### VI. Conclusion

The particular arrangements shown in the Figures should not be viewed as limiting. It should be understood that other embodiments may include more or less of each element shown in a given Figure. Further, some of the illustrated elements may be combined or omitted. Yet further, an exemplary embodiment may include elements that are not illustrated in the Figures.

Additionally, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein.

What is claimed is:

1. A computer-implemented method comprising:
receiving an image of a subject and a target image;
fine-tuning a diffusion model to predict the image of the subject based on a noisy version of the image of the subject, wherein fine-tuning the diffusion model to predict the image of the subject includes learning an auxiliary input that conditions an output of the diffusion model in a semantic embedding space;
executing the fine-tuned diffusion model, with the learned auxiliary input applied thereto and with style information determined from the target image imposed on the fine-tuned diffusion model, to generate a second image of the subject, wherein the second image of the subject depicts the subject in a style of the target image; and
using a subject insertion model to generate an output image that depicts the subject as depicted in the second image integrated into an environment depicted by the target image.

2. The method of claim 1, wherein the auxiliary input comprises a sequence of tokens, and wherein learning the auxiliary input comprises learning one or more tokens of the sequence, and wherein every token of the sequence other than the learned one or more tokens is static.

3. The method of claim 2, wherein learning one or more tokens of the sequence comprises learning a respective embedding for each of the learned one or more tokens.

4. The method of claim 1, wherein fine-tuning the diffusion model comprises
learning at least one rank decomposition matrix for at least one layer of the diffusion model.

5. The method of claim 1, further comprising:
determining, based on the target image, an embedding that represents a style of the target image, wherein executing the fine-tuned diffusion model with style information determined from the target image imposed on the fine-tuned diffusion model comprises injecting the embedding into at least one layer of the fine-tuned diffusion model.

6. The method of claim 5, wherein determining the embedding that represents the style of the target image comprises applying the target image to a trained machine learning model to generate the embedding.

7. The method of claim 6, wherein the trained machine learning model has been trained by Contrastive Language-Image Pre-training, wherein the diffusion model includes UNet, and wherein injecting the embedding into at least one layer of the fine-tuned diffusion model comprises using an adapter model to inject image features of the embedding into at least one layer of the fine-tuned diffusion model.

8. The method of claim 1, wherein the subject insertion model has been trained by:
using a pre-trained subject insertion model to remove a plurality of subjects from respective stylized images to generate a first plurality of training images, wherein the stylized images are not photographic representations of real scenes, and wherein the pre-trained subject insertion model has been trained using photographic representations of real scenes;
removing, from the first plurality of training images, images wherein subject removal has been performed unsuccessfully to generate a first filtered plurality of training images; and
using the first filtered plurality of training images to fine-tune the pre-trained subject insertion model.

9. The method of claim 8, wherein removing, from the first plurality of training images, images wherein subject removal has been performed unsuccessfully includes manually removing, from the first plurality of training images, images wherein subject removal has been performed unsuccessfully.

10. The method of claim 8, wherein removing, from the first plurality of training images, images wherein subject removal has been performed unsuccessfully includes applying the first plurality of training images to a trained predictive model to identify which images of the plurality of training images exhibit unsuccessful subject removal.

11. The method of claim 8, further comprising:
using the fine-tuned pre-trained subject insertion model to remove the plurality of subjects from a subset of the stylized images to generate a second plurality of updated training images, wherein the subset of the stylized images are images whose corresponding to training images of the first plurality of training images wherein subject removal has been performed unsuccessfully;
removing, from the second plurality of training images, images wherein subject removal has been performed unsuccessfully to generate a second filtered plurality of training images; and
using the second filtered plurality of training images to further fine-tune the fine-tuned pre-trained subject insertion model.

12. The method of claim 1, wherein using the subject insertion model to generate an output image that depicts the subject as depicted in the second image integrated into an environment depicted by the target image comprises:
segmenting the subject from the second image and copying the segmented subject onto the target image to generate an intermediate image; and
applying the intermediate image to the subject insertion model to generate the output image.

13. The method of claim 12, wherein applying the intermediate image to the subject insertion model to generate the output image comprises applying, to the subject insertion model, the intermediate image and a mask representing the location and extent of the segmented subject within the intermediate image.

14. The method of claim 1, wherein fine-tuning the diffusion model is performed by one or more processors of a first system, and wherein the method further comprises:
transmitting, from the first system to a second system, an indication of the fine-tuned diffusion model, wherein the second system is optionally a cellphone, tablet, or laptop, and wherein executing the fine-tuned diffusion model to generate the second image of the subject and using the subject insertion model to generate the output image are performed by one or more processors of the second system

15. A method for training a subject insertion model comprising:
using a pre-trained subject insertion model to remove a plurality of subjects from respective stylized images to generate a first plurality of training images, wherein the stylized images are not photographic representations of real scenes, and wherein the pre-trained subject insertion model has been trained using photographic representations of real scenes;
removing, from the first plurality of training images, images wherein subject removal has been performed unsuccessfully to generate a first filtered plurality of training images; and
using the first filtered plurality of training images to fine-tune the pre-trained subject insertion model.

16. The method of claim 15, wherein removing, from the first plurality of training images, images wherein subject removal has been performed unsuccessfully includes manually removing, from the first plurality of training images, images wherein subject removal has been performed unsuccessfully.

17. The method of claim 15, wherein removing, from the first plurality of training images, images wherein subject removal has been performed unsuccessfully includes applying the first plurality of training images to a trained predictive model to identify which images of the plurality of training images exhibit unsuccessful subject removal.

18. The method of claim 15, further comprising:
using the fine-tuned pre-trained subject insertion model to remove the plurality of subjects from a subset of the stylized images to generate a second plurality of updated training images, wherein the subset of the stylized images are images whose corresponding to training images of the first plurality of training images wherein subject removal has been performed unsuccessfully;
removing, from the second plurality of training images, images wherein subject removal has been performed unsuccessfully to generate a second filtered plurality of training images; and
using the second filtered plurality of training images to further fine-tune the fine-tuned pre-trained subject insertion model.

19. An article of manufacture including a non-transitory computer-readable medium, having stored thereon program instructions that, upon execution by a computing device, cause the computing device to perform operations comprising:
receiving an image of a subject and a target image;
fine-tuning a diffusion model to predict the image of the subject based on a noisy version of the image of the subject, wherein fine-tuning the diffusion model to predict the image of the subject includes learning an auxiliary input that conditions an output of the diffusion model in a semantic embedding space;
executing the fine-tuned diffusion model, with the learned auxiliary input applied thereto and with style information determined from the target image imposed on the fine-tuned diffusion model, to generate a second image of the subject, wherein the second image of the subject depicts the subject in a style of the target image; and
using a subject insertion model to generate an output image that depicts the subject as depicted in the second image integrated into an environment depicted by the target image.

20. The article of manufacture of claim 19, wherein the auxiliary input comprises a sequence of tokens, and wherein learning the auxiliary input comprises learning one or more tokens of the sequence, and wherein every token of the sequence other than the learned one or more tokens is static.
